(19) United States
(12) Patent Application Publication
(10) Pub. No.: US 2011/0164952 A1
(43) Pub. Date: Jul. 7, 2011

(54) Grain cart with directional discharge

(76) Inventor: David H. Hollenberg, Thompson, MO (US)

(21) Appl. No.: 12/928,837

(22) Filed: Dec. 21, 2010

Related U.S. Application Data
(60) Provisional application No. 61/335,357, filed on Jan. 6, 2010.

(51) Int. Cl. B60P 1/42; B60P 1/40

(52) U.S. Cl. 414/523

(57) ABSTRACT

A grain cart grain discharge including a pivotable discharge chute having a first position to discharge grain from a first side of a grain cart and a second position to discharge grain from an opposite side of the cart. The discharge chute is movably mounted on a guide and pivotable about the central axis of a grain supply auger mounted at the bottom of a grain hopper. A discharge head rotatably located on an end of the discharge chute opposite the supply auger and a control located on a vehicle, the control controlling the movement of the chute from the first position to the second position and controlling a rotational position of the discharge head without leaving the cab of the vehicle.

### CROSS REFERENCES TO RELATED APPLICATIONS

I hereby claim the benefit under 35 USC 119e of provisional patent application 61/335,357 filed Jan. 6, 2010.

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

This invention relates to carts and systems for handling grain.

2. Brief Description of Prior Art

There is a need to handle grain.

U.S. Pat. No. 4,415,303 shows a grain cart used to handle grain as it is being harvested and after. This patent discloses an auger that can be positioned to dispense from either side of the wagon but the auger takes up space in the cart and thus would be hard to move from side to side and the cart requires manual movement using the handle 38 and thus cannot be used on the fly.

As will be described, the preferred embodiments of the present invention overcome disadvantages of the prior art.

### SUMMARY OF THE INVENTION

A grain cart grain discharge including a pivotable discharge chute having a first position to discharge grain from a first side of a grain cart and a second position to discharge grain from an opposite side of the cart. The discharge chute is movably mounted on a guide and pivotable about the central axis of a grain supply auger mounted at the bottom of a grain hopper. A discharge head rotatably located on an end of the discharge chute opposite the supply auger and a control located on a vehicle, the control controlling the movement of the chute from the first position to the second position and controlling a rotational position of the discharge head without leaving the cab of the vehicle.

### BRIEF DESCRIPTION OF THE DRAWINGS

FIG. 1 shows a view of the device ready for use;

FIG. 2 shows details of the device of FIG. 1;

FIG. 3 shows details of the device;

FIG. 4 shows details of the device.

The present invention will be illustrated on the basis of the figures and following description of a preferred embodiment thereof.

### DESCRIPTION OF THE PREFERRED EMBODIMENT

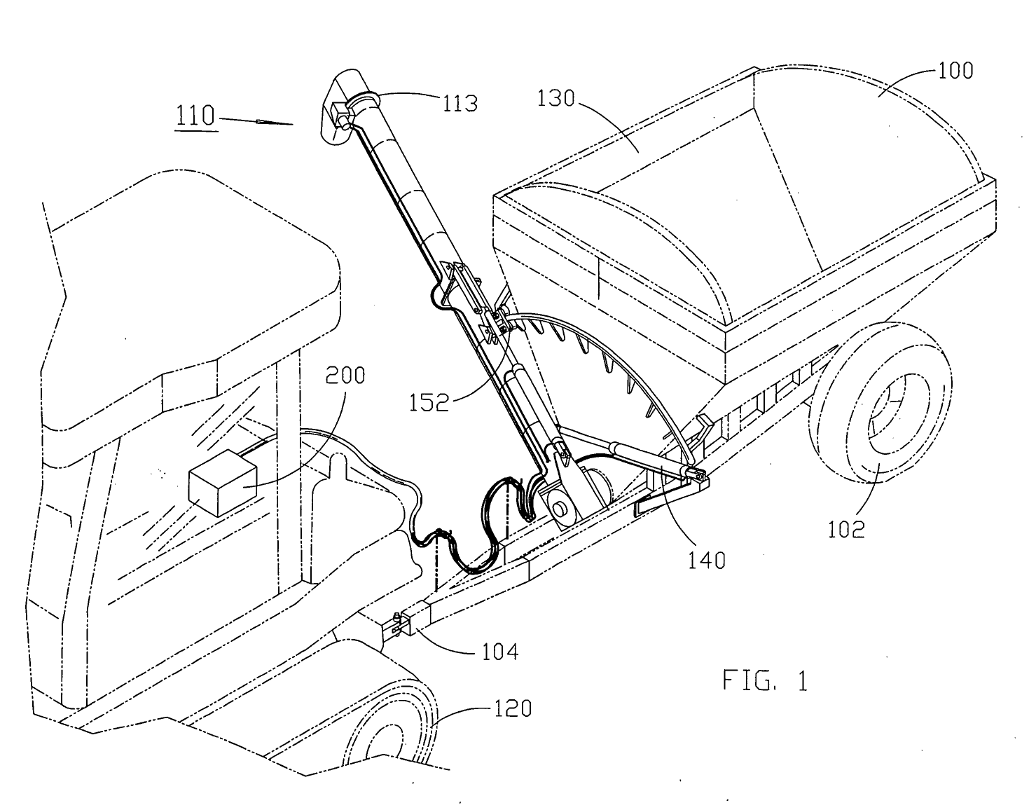

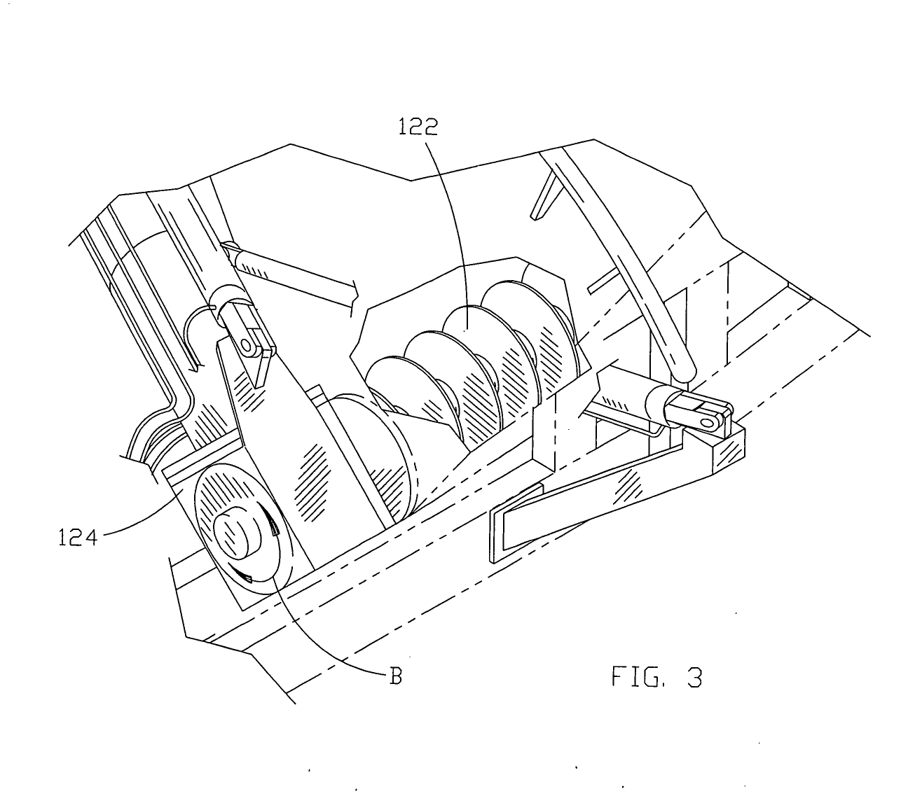

In accordance with the present invention, FIG. 1 shows a grain handling vehicle such as a grain cart 100 with a directional discharge chute 110. The grain cart 100 is pulled by a vehicle 120 such as a combine, tractor or truck, alternatively the cart could have its own power. In the case where the vehicle 120 is a combine, as the combine travels it pours grain into the hopper 130. The grain cart 100 includes a pair of tires 102 and a tongue 104. The discharge chute 110 is in communication with an auger (FIG. 3) in the base of the hopper 130. A control 200 in or on the vehicle 120 can be used to control the operation of the grain cart 100 and chute 110.

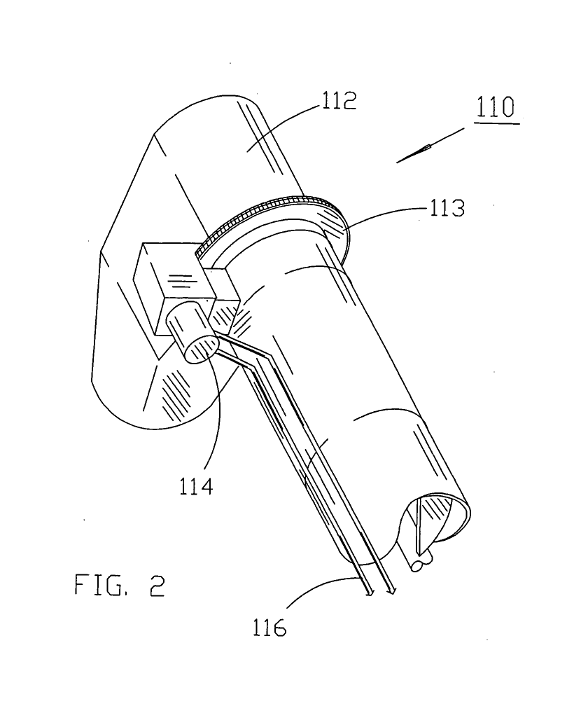

FIG. 2 shows that the discharge chute 110 includes a discharge head 112 rotationally mounted to the chute 110, the discharge head 112 can rotate 360 degrees about the center axis of the chute 110 using a means such as a gear 113 or chain drive for example. The position of the discharge head 112 is controlled by a motor 114 that can be electric or hydraulic for example. Control lines 116 control the operation of the motor 114 and the control lines 116 lead back to the cab of the vehicle 120 to the control 200 such that an operator can control the rotational position of the discharge head 112 from the cab of the vehicle 120. The discharge chute 110 is designed to discharge grain while the grain cart 100 is in motion such as during harvesting, this allows harvest to proceed as rapidly as possible as often times the harvest of grain and agricultural products is time sensitive. The discharge chute 110 discharges grain into a truck or other vehicle driving alongside the cart 110. The discharge head 112 can be positioned to either side of the cart 100 from the cab of the vehicle 120 without stopping.

FIG. 3 shows that the grain cart 100 includes a hopper auger 122 in the base of the hopper 130. The auger 122 runs the length of the cart 110 and moves grain from the cart 110 to the discharge chute 110 through a rotational coupling 124. The discharge chute 110 includes an auger (FIG. 2) that carries the grain from the auger 122 to the discharge head 112. The arrow ‘B’ shows that the coupling 124 can rotate about the axial length of the auger 122 as the chute 110 rotates from one side of the grain cart 100 to the other.

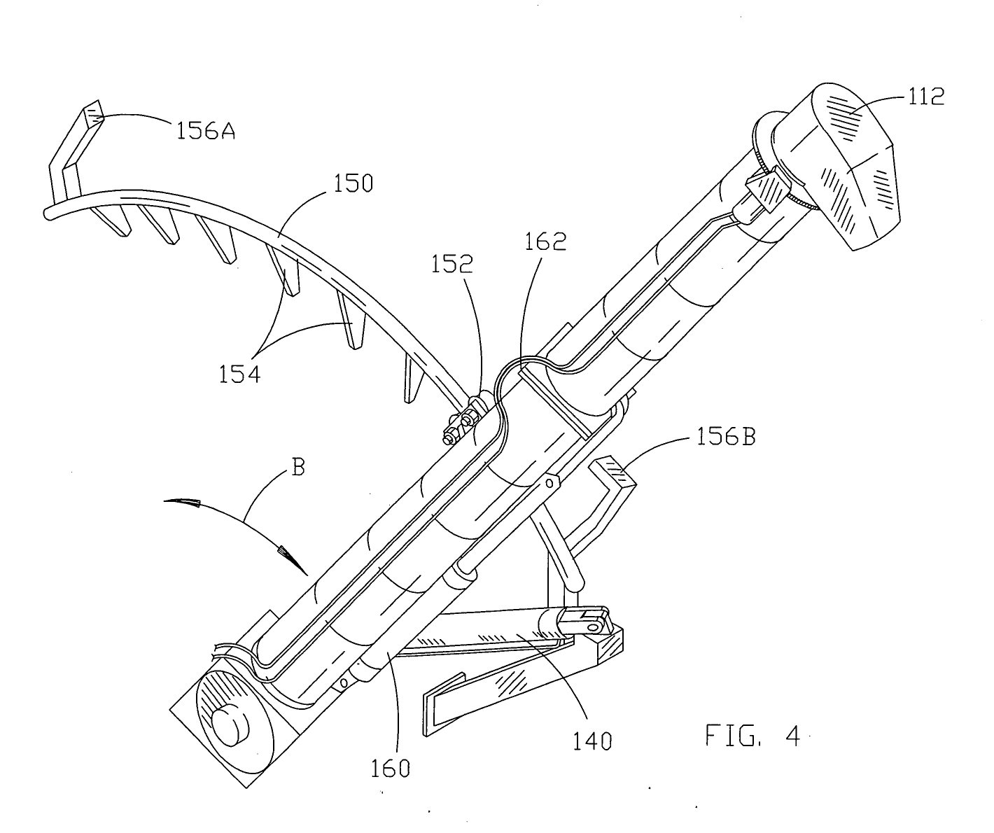

FIG. 4 shows the discharge chute 110 and the position control cylinder 140 with the trailer removed for clarity. The discharge chute 110 is attached to the cylinder 140 that controls the rotation of the discharge chute 110 about the axis of the auger 122. The chute 110 can be mounted on an arcuate guide track 150 that supports the long discharge chute 110 on roller 152. The track 150 is held on the front of the trailer 110 using supports such as weldments 154 and the track 150 include positive stops 156 a, b that stop the motion of the chute 110 along the track 150. The discharge chute 110 includes a cylinder 160 that allows the chute 110 to fold in half along break 162 such that the chute 110 is more compact for travel.

In use the grain cart 100 is pulled behind a vehicle 120 such as a combine. The discharge chute 110 can be controlled from the vehicle 120 without the user leaving the vehicle 120. The chute 110 can start in the position as shown in FIG. 1. The auger 122 can be turned on and grain will flow through the chute 110 and out the discharge head 112. If needed the chute 110 can then be moved to the opposite side of the grain cart 100. First the auger 122 would be turned off. Then the operator can use the controller 200 to begin moving the chute 110 to discharge from the opposite side of the grain cart 100 adjacent stop 156b. The cylinder 140 will contract from the position shown in FIG. 1 toward that shown in FIG. 4. As the chute 110 is moving the discharge head 112 can also rotate to the position to discharge grain from the opposite side as shown in FIG. 4. As the chute 110 moves it is guided by wheels or rollers 152 along track 150. Once in the position shown in FIG. 4 the chute 110 will stop either as the controller 200 stops power or as the guide rollers 152 encounter positive stop 156b. Once in place the auger 122 can again be turned on. All of this operation is achieved without the operator leaving the vehicle 120 or control which is convenient and safe for the operator. It is possible for the operator to position the chute 110 at any angular position along the arcuate guide track 150 and also to position the discharge head 112 at any rotational position on the end of the chute 110. When it is desired to transport the grain cart 100 on the road the chute 110 can be folded down using cylinder 160 by first rotating the chute 110 back to the positive stop 156 a and then by contracting the cylinder 160 which will cause the chute 110 to separate at hinge surface 162 and the upper portion of the chute will fold down on the lower portion.

I claim:

1. A grain cart including;
a pivotable discharge chute having a first position to discharge grain from a first side of a grain cart and a second position to discharge grain from a second side of said cart;
said discharge chute movably mounted on a guide and pivotable about the central axis of a grain supply auger;
a discharge head rotatably located on an end of said discharge chute opposite said grain supply auger
a control located on a vehicle, said control controlling the movement of said chute from said first position to said second position and controlling a rotational position of said discharge head.

2. The grain cart of claim 1 wherein the vehicle is a tractor used to pull the grain cart.

3. The grain cart of claim 1 wherein the grain supply auger is in the base of said cart and supplys grain from the cart to the discharge chute and wherein the discharge chute includes a second auger.

4. The grain cart of claim 1 wherein said guide includes rollers on said discharge chute and an arcuate track mounted on said cart such that as said discharge chute pivots from said first position to said second position said rollers travel along said arcuate track.

5. The grain cart of claim 1 wherein said track is welded to a front surface of said track and said guide includes a hydraulic cylinder that moves said discharge chute from said first position to said second position.

6. A grain cart including;
a pivotable discharge chute having a first position to discharge grain from a first side of a grain cart and a second position to discharge grain from a second side of said cart;
said discharge chute pivotably mounted on a guide;
a discharge head rotatably located on an end of said discharge chute opposite said grain supply auger
a control located on a vehicle, said control controlling the movement of said chute from said first position to said second position and controlling a rotational position of said discharge head.

7. The grain cart of claim 6 wherein said guide includes at least one roller on said discharge chute and an arcuate track mounted on said cart such that as said discharge chute pivots from said first position to said second position said at least one roller travels along said arcuate track.

8. The grain cart of claim 7 wherein the vehicle is a tractor used to pull the grain cart.

9. The grain cart of claim 7 wherein said track is welded to a surface of said track and said guide includes a powered cylinder that moves said discharge chute from said first position to said second position.

10. The grain cart of claim 7 wherein the grain supply auger is in the bottom of said cart and supplys grain from the cart to the discharge chute and wherein the discharge chute includes a second auger.

11. A cart including;
a pivotable discharge chute having a first position to discharge from a first side of a cart and a second position to discharge from a second side of said cart;
said discharge chute movably mounted on a guide and pivotable about the central axis of a supply auger;
a discharge head rotatably located on an end of said discharge chute opposite said supply auger;
a control controlling the movement of said chute from said first position to said second position and controlling a rotational position of said discharge head.

12. The cart of claim 11 wherein said guide includes at least one roller on said discharge chute and a track mounted on said cart such that as said discharge chute pivots from said first position to said second position said at least one roller travels along said track.

13. The cart of claim 12 wherein said track is welded to a surface of said track and said guide includes a powered cylinder that moves said discharge chute from said first position to said second position.

14. The cart of claim 13 wherein the supply auger is in the bottom of said cart and supplys from the cart to the discharge chute and wherein the discharge chute includes a second auger.
